(19) United States
(12) Patent Application Publication
(10) Pub. No.: US 2021/0350267 A1
(43) Pub. Date: Nov. 11, 2021

(54) DATA PROCESSING APPARATUS AND DATA PROCESSING METHOD

(71) Applicants: THE UNIVERSITY OF TOKYO, Tokyo (JP); JAPAN SCIENCE AND TECHNOLOGY AGENCY, Saitama (JP); THE BOARD OF TRUSTEES OF THE LELAND STANFORD J.U., Stanford, CA (US)

(72) Inventors: Timothee Guillaume LELEU, Tokyo (JP); Kazuyuki AIHARA, Tokyo (JP); Yoshihisa YAMAMOTO, Tokyo (JP); Peter MCMAHON, Menlo Park, CA (US)

(21) Appl. No.: 17/263,564

(22) PCT Filed: Jul. 31, 2019
(86) PCT No.: PCT/US2019/044266

§ 371 Date: Jan. 27, 2021

(30) Foreign Application Priority Data
Jul. 31, 2018 (US) PCT/US2018/044469

(51) Int. Cl. G06N 10/00; G06F 15/78; G06F 15/82; G06G 7/12

(52) U.S. Cl. CPC G06N 10/00; G06F 15/7892; B82Y 10/00; G06G 7/12; G06F 15/82

(57) ABSTRACT

A data processing apparatus is configured to solve a specific problem using a simple hardware. The data processing apparatus comprises a state data processing unit configured to iterate update of state data by a predetermined time evolutional process, a cost evaluation unit configured to evaluate a cost function for current state data, and an error calculation unit configured to calculate error values relating to amplitude homogeneity of the current state data, wherein the state data processing unit performs the time evolutional process on the state data to update the current state data based on the cost function and the error values which are calculated by the error calculation unit.

### BACKGROUND

### Technical Field

The present invention relates to a data processing unit that solves combinatorial optimization problems.

### Related Arts

In order to solve combinatorial optimization problems, classical digital computers employ algorithms that are compiled to run on general-purpose central processing units (CPU). For many years, it has been possible to miniaturize the digital hardware (e.g., the number of transistors in a CPU) at a rapid pace. However, the limits of the minimization of digital components are nearly reached, as the very tightly packed transistors cannot be made to get enough energy efficiency while functioning robustly. From a theoretical viewpoint, the computational process employed by these classical computers can generally be described in the framework of the von Neumann architecture.

Given that computation by these classical computers can be formalized using the Turing machine, these have “universal” computing capabilities as proven by the Church-Turing thesis, only when resource limitations are ignored. In addition to the limit of the number of logical operations performed by the CPU described here-above, the finite bandwidth between CPU-unit and memory is another well-known bottleneck limiting information flow in these computers.

In order to circumvent the limitations of classical computers, it has been proposed to consider “nonconventional” data processors. These novel computers do not necessarily have universal computing capabilities, but are optimized for specific computational tasks. Gain in performance can be achieved by implementing the processing of information directly using lower-levels of abstraction that are close to the physical layer, rather than relying on the higher levels. Computation at the lowest levels can now be achieved using “soft” data processors whose internal structure is dynamically reorganized in order to fit a specific purpose. This allows notably to perform massive parallel computation, in which memory and processing are collocated.

Moreover, it has been proposed to utilize the analog signals of the data processors directly, rather than the binary states used in classical computers. The analog state can be implemented physically in the electronic domain by, for example, electronic components operating in the subthreshold regime, or using non-linear optics. Although such analog computers can be simulated by digital ones in theory, they allow much faster processing for certain type of dedicated problems, notably the ones that involve simulating differential equations. The underlying motivation for developing such device is that the physical units of the hardware that are used for computation can encode much more information than just 0s and 1s. Thus, gain in resources can be obtained by computing directly at the lower physical level, rather than only at the higher logical one.

In particular, recently proposed analog computers such as the analog Hopfield neural networks (US patent U.S. Pat. No. 4,660,166) or optical analog computers such as the Coherent Ising Machine (such as U.S. Pat. No. 9,411,026) can solve combinatorial optimization problems approximately.

Currently, these machines allow taking advantage of the parallel calculation achieved by the analog hardware in order to do fast computation (US patent U.S. Pat. No. 4,660,166). It is also interesting to underline the conceptual proximity of these devices with neural networks. Recent advances in the field of computational neuroscience can be applied for developing novel analog computing schemes that are inspired by analog processing occurring in the brain.

Unconventional neuro-inspired data processors such as GPUs (Graphics Processing Units), Tensor Processing Units (TPUs), FPGAs, etc., have been applied successfully to the field of classification and outperforms state-of-the art methods that employ classical hardware, as exemplified by the recent trend in deep learning networks.

However, analog neural networks, descried above, have two limitations. First, although they can find good approximate solutions to combinatorial optimization problems by mapping the cost function (or objective function) to the system's energy function (or Lyapunov function, which is defined usually when connections are symmetric), they do not guarantee in general finding the optimal solution to combinatorial optimization problems. Indeed, these systems can get caught in local minima of the energy function in the case of non-convex problems. Analog neural networks are usually dissipative systems, and it has been proposed in the framework of the Coherent Ising machine to improve the solution quality by setting the gain of the system to its minimal value, at which only the solution with minimal loss is stable, and other configurations are unstable. But, the fact that the amplitudes of analog variables are in general heterogeneous (i.e., not all equal) result in the wrong mapping of the objective function by the energy function, and operation at the minimal loss regime is not guaranteed to converge to the optimal solution of a given combinatorial optimization problem.

For the second limitation; the constraints imposed in constrained optimization problems, which are usually converted into soft constraints by adding penalty terms in the cost function, cannot be properly taken into account. Indeed, using soft constraints (i.e., penalty terms) is known to result in convergence problems, notably because the penalty terms tend to interfere with one another in the summation of the global cost function. Moreover, the penalty terms usually have very different scales that must be corrected using carefully chosen constant coefficients.

Various schemes have been proposed in order to resolve these issues. In the case of the popular simulated annealing scheme, which is a stochastic search over the digital states, the convergence to the optimal solution is assured when the “temperature” of the system is gradually decreased at the proper rate. Although the convergence can be proven analytically, it is in practice difficult to find the optimal scheduling that allows solving efficiently a given combinatorial optimization problem (L. Ingber, Mathematical and computer modelling, 18, (29), 1993).

There is also the concept of computation close to the physical layer which also extends to quantum analog devices, which aim at taking advantage of quantum dynamical properties of the hardware. There have been recent attempts at building quantum annealing devices, in which the strength of an initially strong transverse field is gradually decreased. In the limit of the adiabatic regime, such system remains in the ground-state and reaches the state encoding for the optimal solution of the combinatorial optimization problem once the transverse field vanishes. Real physical implementation of such machine, such as proposed by D-wave (for example, US patent U.S. Pat. No. 6,803,599), suffers from interactions with the environment that destroys quantum effects in these devices, and is limited to special topology of connections (chimera graph) between its components that requires an embedding of the combinatorial optimization problem into this topology that is costly in resources. Because of these limitations, it has not been widely recognized that such quantum devices offer an important computational advantage compared to analogous classical methods such as simulated annealing for solving general types of problems.

As discussed above, in the related arts, it is becoming hard to improve the speed for solving a specific problem with a simple hardware in both digital and analog computing devices. Thus, there is a need for a computing device that can solve a specific problem fast with a simple hardware.

### SUMMARY

The present invention provides, a data processing apparatus which is configured to solve a given problem, comprising:

a state data processing unit configured to iterate update of state data by a predetermined time evolutional process;

a cost evaluation unit configured to evaluate a cost function for current state data; and

an error calculation unit configured to calculate an error value relating to amplitude homogeneity of the current state data;

wherein the state data processing unit performs the time evolutional process on the state data to update the current state data based on the cost function and the error value which is calculated by the error calculation unit.

According to the present invention, a computing device that can solve a specific problem fast with a simple hardware can be provided.

Thus, there are a number of advantages and there is no requirement that a claim be limited to encompass all of the advantages.

In addition, the foregoing has outlined rather broadly the features and technical advantages in order that the detailed description of the invention that follows may be better understood. Additional features and advantages will be described hereinafter which form the subject of the claims.

### BRIEF DESCRIPTION OF THE DRAWINGS

For a more complete understanding, and the advantages thereof, reference is now made to the following description taken in conjunction with the accompanying drawings.

FIG. 1 illustrates the schematic structure of the data processing apparatus of an embodiment of the present invention.

FIG. 2 illustrates the example of functional structure of the data processing apparatus of an embodiment of the present invention.

FIG. 3 illustrates the schematic structure of the error calculation unit of an embodiment of the present invention.

FIG. 4 illustrates an example of the state data processor of an embodiment of the present invention.

FIG. 5 illustrates a schematic functional structure of an embodiment of the present invention.

FIG. 6 illustrates a schematic flow chart of a process executed in the data processor of an embodiment of the present invention.

### EMBODIMENTS

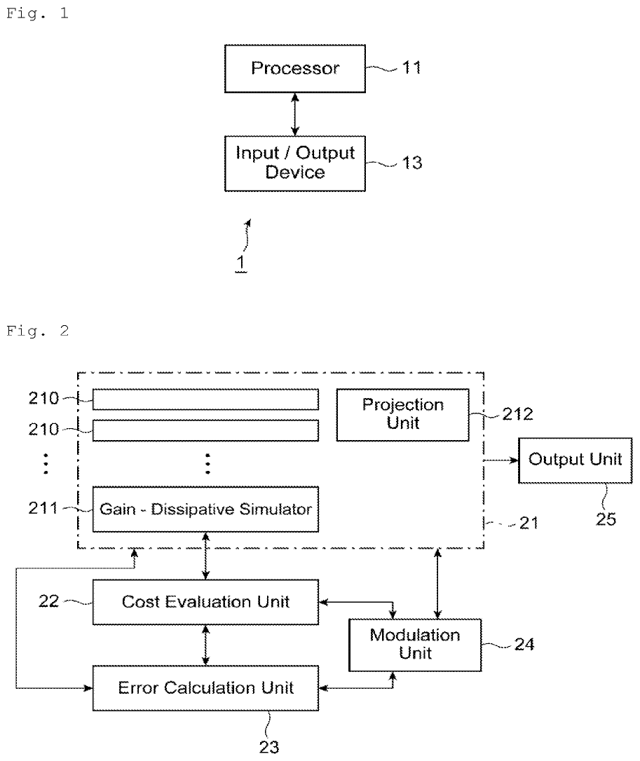

One of the preferred embodiments of this invention is, as shown in FIG. 1, a data processing apparatus 1 which comprises a processor 11, and an input-output device 13.

In this embodiment, similar to Ising machines and Hopfield neural networks, the data processing apparatus 1 includes state-encoding units, in which the binary variables of a combinatorial optimization problem are mapped to analog variables, as described later. In addition to this, the data processing apparatus 1 also includes another subsystem, called error-encoding units, that corrects the mapping between the steady-states of the data processing apparatus 1 and the configurations of lower cost values of the combinatorial optimization problem, and the state-encoding units are connected asymmetrically to the error-encoding units.

The processor 11 may be an FPGA which includes logic gates and memory blocks. In this embodiment, the processor 11 is configured to iterate update of the state data by a predetermined time evolutional process, to evaluate a cost function for the state data, and to calculate an error value relating to amplitude homogeneity of the state data. When updating the state data, the processor 11 also takes advantage of the error value and the cost function. The detail process in the processor 11 will be described later.

The memory block in the processor 11 may store the data used in the process in the logic gates of the processor 11, such as the state data.

The input-output (I/O) device 13 may include an input device such as a keyboard, a mouse, and the like. The I/O device 13 may also include a display to output information such as the state data, the value of the cost function, or the like according to instructions from the processor 11.

The processes in the processor 11 are described hereinafter. In the following example, the problem to be solved by the data processing apparatus 1 according to an embodiment of present invention is a combinational optimization problem. In the combinational optimization problem, a cost function is defined, and as the cost function of the combinatorial optimization problem is minimized, the combinatorial optimization problem is solved.

Here, the cost function is denoted by V⁽⁰⁾ (σ), where V⁽⁰⁾ (σ) is a real number for any vector σ, and the vector σ is σ={σᵢ}ᵢ(i=1, 2, . . . , N), with σᵢ=±1. The cost function V⁽⁰⁾ (σ) is defined by the set of parameters {M₀ₖ}ₖ (k=1, 2, . . . ) where M₀ₖ is a vector, a matrix, or, more generally, a tensor. The number of Boolean variables (or size of the problem) is denoted by N.

In the case of constrained optimization problems, acceptable solutions constitute a subset, denoted by S, of the whole space of configurations. Depending on the constraints of a given combinatorial optimization problem, the subset S can be defined using equality and/or inequality constraints given as follows:

$$σ ∈ S ⇔ \{ \begin{matrix}{A}_{k} σ = {b}_{k} , ( equality constraints ) & \\ {C}_{{k}^{′}} σ \leq {d}_{{k}^{′}} , ( inequality constraints ) & \end{matrix} \qquad ( 1 )$$

here, k, k′=1, 2, . . . , K.

The matrices and vectors Aₖ, Cₖ, bₖ, and dₖ are defined by another set of parameters denoted by {Nₖᵢ}ᵢ or {Mₖᵢ}ᵢ where k is the index of the constraint with k=1, 2, . . . , K, i=1, 2, . . . .

The constraints are classified into two categories. The first set of constraints, called soft constraints of type I, are realized by adding penalty terms to the cost function and projecting the system in a valid subspace defined by these constraints. The total cost function V* that takes into account these constraints is given as follows:

$${V}^{*} ( σ ) = \frac{1}{{q}_{0}} {V}^{( 0 )} ( σ ) + \frac{1}{{q}_{1}} {U}^{( 1 )} ( σ ) + . . . \frac{1}{{q}_{{K}_{I}}} {U}^{( {K}_{I} )} ( σ ) \qquad ( 2 )$$

where U^{(k)} is the penalty term that is imposed by the constraint k. Here, qₖ is a constant positive parameter for k=1, 2, . . . , K_{I}, and K₁ is the total number of constraints in this subset. The value of the penalty term U^{(k)}(σ) is minimal when the vector σ satisfies the constraint k. The penalty terms U^{(k)} (σ) are functions which depend on the parameters {Mₖᵢ}ᵢ, and the projection P to the valid subspace, and must be given as an input to the proposed system.

The second set of constraints, called soft constraints of type II, are realized using an error-detection/error-correction feedback loop. Penalty terms V^{(k)}, which depend on parameters {Nₖᵢ}ᵢ, with k=1, 2, . . . , K_{II}, (and let K_{I}+K_{II}=K), must also be defined, and are used for error correction. Moreover, functions gₖ, which are positive when the constraints are not realized, are used for error detection. The functions gₖ are negative, when the constraints are realized.

The choice of U^{(k)}, V^{(k)}, P, and gₖ depends on the combinatorial problems to be solved and their constraints. In other words, the U^{(k)}, V^{(k)}, P, and gₖ are set by the user of the data processing apparatus 1.

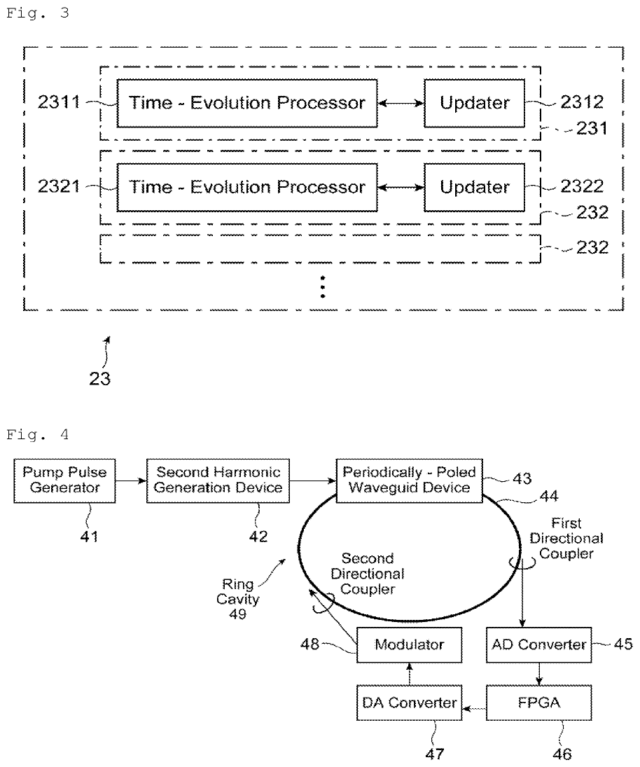

An exemplary functional construction of the processor 11 is shown in FIG. 2. As shown in FIG. 2, one of the examples of the processor 11 is configured to be functionally include a state data processor 21, a cost evaluation unit 22, an error calculation unit 23, a modulation unit 24, and an output unit 25.

The state data processor 21 is configured to iterate update of state data by a predetermined time evolutional process. The state data is a set of fixed-point variables xᵢ (i=1, 2, . . . N), which is obtained by, for example, encoding the analog state.

The state data processor 21, in this embodiment, iterates update of state data by a predetermined time evolutional process, projects the updated state data onto the valid subspace, and stores the projected updated state data, as new state data, in the memory block.

Specifically, the state data processor 21 has processing units 210, a gain-dissipative simulator 211, and a projection unit 212. Each processing unit 210 is provided for processing state data xᵢ (i=1, 2, . . . N), respectively. The gain-dissipative simulator 211 is an isolated (non-coupled) unit. The gain-dissipative simulator 211 gets state data xᵢ and a linear gain p, and calculates a gradient descent of the potential V_{b}. The calculation can be simplified to the following ordinary differential equation system that describe a gradient descent when Iᵢ=0:

∂ₜxᵢ=f(xᵢ)+Iᵢ. (3)

where f(xᵢ)=−∂V_{b}/∂xᵢ and V_{b} is the energy function or Lyapunov function of the isolated (non-coupled) units, such as a potential function:

V_{b}=−(−1+p)xᵢ²/2+xᵢ⁴/4,

and Iᵢ will be described later.

The energy function V_{b} represents the paradigmatic bistable potential (archetype monostable/bistable potential) which can be monostable (when p<1) or bistable (when p>1) according to the value of the linear gain p. When V_{b} is bistable, the state data xᵢ converge to binary states at the lowest points of the potential V_{b} when Iᵢ=0. Moreover, Iᵢ represents an external analog injection signal to the i-th processing unit 210. The external analog injection signal will be described later.

The formula (3) can be rewritten as follows:

∂ₜxᵢ=(−1+p)xᵢ−x³ᵢ+Iᵢ, (4)

in which −xᵢ, pxᵢ, and −x³ᵢ represents the terms related to the loss, the linear gain, and saturation of the state x, respectively.

Note that the dynamics are described herein in the continuous-time domain using ordinary differential equations (ODEs), but that the system can also be operated in the discrete-time domain. The conversion from continuous to discrete time can be obtained by a simple Euler approximation, or the like, of the ODEs describing the system.

The coupling between the processing units 210 of the state data processor 21 is implemented using the injection term Iᵢ given as follows:

$$\begin{matrix}{I}_{i} = {\sum }_{k} {I}_{i}^{( k )} . & ( 5 ) \\ where & \\ {I}_{i}^{( 0 )} = - {ϵ}_{0} {e}_{i}^{( 0 )} \frac{\partial {V}^{*} ( x )}{\partial {x}_{i}} . & ( 6 ) \\ {I}_{i}^{( k )} = - {ϵ}_{k} {e}_{i}^{( k )} \frac{\partial {V}^{k} ( x )}{\partial {x}_{i}} . & ( 7 )\end{matrix}$$

here, k=1, 2, . . . K_{II}.

In the formulae (4) and (5), vector e^{(k)} (whose elements are eᵢ^{(k)}, 1=1, 2, . . . ) are the error signals; V* is the cost function with penalty terms that take into account soft constraints of type I; and V^{(k)} are the penalty terms related to the kth soft constraint of type II. Lastly, ∈ₖ are positive real parameter values. The types of constraints are described later.

The effect of the input Iᵢ is to impose a gradient descent of the potentials v^{(k)} (x). Note, however, that the gradient ∂V^{(k)}(x)/∂xᵢ is modulated by eᵢ^{(k)}, i.e., the gradient vector is defined using the state-space, and is rescaled by the error signals. Each error signal eᵢ^{(k)} rescales the space vector x differently according to the constraint being imposed.

Lastly, the gradients are summed over the indices k, taking into account the soft constraints of type II. Therefore, multiple constraints are in competition in the sum. A given constraint eventually wins when the amplitude of its rescaled gradient vector becomes much larger than the other ones.

The Projection unit 212 performs projection of the state data onto a predetermined subspace. Specifically, in this embodiment, the state data vector x is projected onto the valid subspace at each iteration of updating the state data vector x using a projection operator P which is predetermined according to the constraints of type I.

The projection is similar to Aiyer's method for the Hopfield Network.

The effect of the projection operator can be described by considering the Euler steps of the time-evolution of vector x given as follows:

xᵢ(t+dt)=x′ᵢ(t)+[ƒ(x′ᵢ)+Iᵢ(x′)]dt (8)

where x′ᵢ(t) is the projection of xᵢ(t) on the valid subspace using the projection operator P:

x′ᵢ(t)=P[xᵢ(t)] (9)

If there are no soft constraints of type I, the projection P is the identity operator, and the vector x′ is equal to the vector x.

Note that the time-evolution of the system can also be described in the continuous time domain using algebraic differential equations in order to take into account the projection P.

The cost evaluation unit 22 calculates the cost function of current state data.

The error calculation unit 23 calculates at least an error value relating to amplitude homogeneity of the current state data. In this embodiment, the role of these error signals is to: (1) correct the heterogeneity in amplitudes of the state encoding units, and (2) allow an appropriate mapping of the constraints. Each error-encoding unit is usually connected to only a subset of state-encoding units. Note that the correction of amplitude heterogeneity can be interpreted as an equality constraint of an optimization problem on the analog space.

In other words, combinatorial optimization on binary variables is an optimization problem on analog variables with the constraint that all amplitudes of the analog states are equal.

As shown in FIG. 3, the error calculation unit 23 includes an error calculation subunit 231 and a plurality of subunits 232.

The error calculation subunit 231 which calculates the error for amplitude heterogeneity, e⁽⁰⁾, includes a time-evolution processor 2311 and an updater 2312. The time-evolution processor 2311 takes a target amplitude a with a >0 and a rate of change of this error signal β₀, which are specified by the user at least at the time of initialization, and gives the error signals e⁽⁰⁾, which is one of e^{(k)} of index k=0 and that is related to the minimization of the cost function V*. These error signals correct the heterogeneity in amplitudes of the state data vector x.

Specifically, the time-evolution processor 2311 calculates the error signals e⁽⁰⁾ as:

∂ₜeᵢ⁽⁰⁾=−β₀(xᵢ²−a)eᵢ⁽⁰⁾. (10)

The updater 2312 updates the current eᵢ⁽⁰⁾) by adding ∂ₜ eᵢ⁽⁰⁾dt to get updated eᵢ⁽⁰⁾ and stores eᵢ⁽⁰⁾ in the memory block as the error signal for the next iteration.

Each one of the subunits 232 which calculates the error for constraints also includes a time-evolution processor 2321 and an updater 2322. The time-evolution processor 2321 takes a target function gᵢ and a rate of change of this error signal βᵢ, which are specified by the user at least at the time of initialization, and gives the error signals e⁽ⁱ⁾, which is one of e^{(k)} of index k=i and that is related to the minimization of the cost function V*. These error signals enforce the constraints of the problem upon the state data vector x.

Specifically, the time-evolution processor 2311 calculates the error signals epi) as:

∂_{L}e₁^{(k)}=−β₁g^{(k)}(e₁^{(k)},x)

where the x is the vector of the state data, and g^{(k)} (eᵢ^{(k)},x) is related to a constraint of the problem to be solved.

Note that if there are no constraints according to the problem to be solved, any subunits 232 are not always required.

The updater 2322 updates the current eᵢ^{(k)} by adding ∂ₜ eᵢ^{(k)}dt to get updated eᵢ^{(k)}:

eᵢ^{(k)} [symbol] eᵢ^{(k)}+∂ₜeᵢ^{(k)}dt

and stores updated eᵢ^{(k)} in the memory block as the error signal for the next iteration.

The error calculation unit 23 outputs current error values eᵢ^{(k)} (i=0, 1, 2 . . . ) to the state data processor 21.

The modulation unit 24 performs calculation of parameter values such as a linear gain p, a target amplitude a, and a rate of change of error values βₖ based on the current state data. If the modulation unit 24 gives the parameters such as a target amplitude to the error calculation unit 23, the error calculation unit 23 may take advantage of the parameters given from the modulation unit 24, instead of values which are designated by a user.

In this embodiment, the modulation unit 24 converts the analog state x into an acceptable Boolean configuration σ, with σ=C[x], at each step of the computation. Next, the modulation unit 24 takes advantage of this configuration in order to calculate the current value of the cost function V⁽⁰⁾.

In an example, the modulation unit 24 calculate the current value of the cost function V⁽⁰⁾ as:

$${V}^{( 0 )} = - \frac{σ \cdot {h}_{0}}{2} = - \frac{σ \cdot {M}_{01} σ}{2} \qquad$$

where h represents an internal field calculation such as applying the matrix M₀ᵢ from the left of σ (also known as coupling calculation); h=M₀ᵢσ, and dot means a dot product.

Lastly, the modulation unit 24 modulates the linear gain p and the target amplitude a as follows:

a=α+ρ₁ϕ(δΔV⁽⁰⁾) (12)

p=π+ρ₂ϕ(δΔV⁽⁰⁾) (13)

where

ΔV⁽⁰⁾>Vₒₚₜ⁽⁰⁾−V⁽⁰⁾(t).

Here, V⁽⁰⁾ (t) is the value of the cost function associated with the state x(t), and Vₒₚₜ⁽⁰⁾ is the target energy. In an example, Vₒₚₜ⁽⁰⁾ can be set to the lowest energy found during iterative computation, i.e.

$${V}_{o p t}^{( 0 )} = {min}_{{t}^{′} \leq t} {V}^{( 0 )} ( {t}^{′} ) \qquad$$

or can be set to the minimum value of the cost function V⁽⁰⁾ if it is known. The function
ϕ
is a sigmoidal (for example tangent hyperbolic) function, and
δ>0,ρ₁,ρ₂
are constant predetermined parameters where the both
ρ₁
and
ρ₂
can be ether positive or negative.

If target amplitude a or linear gain p is modulated according to

### ϕ(δΔV⁽⁰⁾),

ρ₁>0
or
ρ₂>0.

On the other hand, if target amplitude a or linear gain p is modulated against to

### ϕ(δΔV⁽⁰⁾),

ρ₁<0
or
ρ₂<0.

Note that other parameters, such as the rates

βₖ
can also be modulated.

The efficiency of the proposed scheme depends on the choice of parameter values for

α, π
and others.

It will be shown that the parameters can be chosen without prior tuning by using the spectral decomposition (the maximum eigenvalues) of the coupling matrix.

The output unit 25 outputs current state data x. The output unit 25 can be configured to output a cost function for the current state data in addition to the state data.

In an embodiment of the present invention, a data processor includes the error correction scheme described above. Error detection is achieved by, for example, considering auxiliary analog dynamical variables called error signals. A set of error correcting variables is used for correcting the amplitude heterogeneity that results in the wrong mapping of the objective function by the system.

Moreover, another set of variables and the projection on a valid subspace is considered for imposing constraints of the optimization problems. The error control utilizes asymmetrical error-correction, and error detection feedback loop.

Lastly, the dynamics of the error signals generally depends on the current Boolean configuration, which is in turn encoded by the analog state, in order to detect errors at the logical level. However, the error signals themselves are analog and modify the current state-encoding variables in an analog way.

The data processor 1 of this embodiment comprises the modules described above, and operates as below.

First of all, the data processor 1 of this embodiment, as shown in FIG. 6, initializes the state data xᵢ (i=1, 2, . . . N) by a predetermined method (S1), for example, the data processor 1 initializes the state data by generating a random Boolean values.

Then, the data processor 1 calculate parameter modulation according to the state data xᵢ and the set of parameters {M₀ₖ}ₖ (k=1, 2, . . . ) of the cost function (S2).

In this step S2, the data processor 1 calculates modulated linear gain p, modulated target amplitude a, current value of the cost function V⁽⁰⁾:

$${V}^{( 0 )} = - \frac{σ \cdot {h}_{0}}{2} = - \frac{σ \cdot {M}_{01} σ}{2} , \\ {V}^{( 0 )} = - \frac{σ \cdot h}{2} = - \frac{σ \cdot {M}_{0 i} σ}{2} ,$$

if type I constraint exists.

In an example, M₀₁ and M₀₂ are matrices and M₀₃ is a vector. M₀₁, M₀₂, and M₀₃ define the cost function V⁽⁰⁾. Similarly, if type I constraint exists, M₁₁ and M₁₂ are matrices, and M₁₃ is a vector. Here let k denotes the constraint k (or when k=0, this is the objective function V⁽⁰⁾) defined by U^{(k)}; M₁₁, M₁₂, and M₁₃ define the first constraint (k=1) defined by U⁽¹⁾.

βₖ is the rates of change of error signals.

The data processor 1 also calculates in this step S2, acceptable Boolean configuration σ of the state data xᵢ. The detail operation in this step S2 is already described as the operation of the modulation unit 24.

The data processor 1, then updates error variables for amplitude heterogeneity and constraints (S3). The error variables are calculated with modulated target amplitude, the rates of change error variables obtained in step S1, and a target function g as:

eᵢ⁽⁰⁾(t+dt)=eᵢ⁽⁰⁾(t)−β₀(t)[x′ᵢ(t)²−a])eᵢ⁽⁰⁾(t)dt,

and

eᵢ^{(k)}(t+dt)=eᵢ^{(k)}(t)+βₖgᵢ^{(k)}(σ,eᵢ^{(k)}(t))dt.

Here, the function g is defined by the constraint of the problem to be solved.

Note that the prime sign on the state data xᵢ means that this is the projection of the state data xᵢ onto a valid subspace as previously described.

The data processor 1 also calculates coupling terms such as

h₀=M₀₁σ,

or

h₀=M₀ᵢσ,

if type I constraint exists,
and

hₖ=Nₖᵢσ

where Nₖᵢ are defined from constraints type II, and the data processor 1 calculates gain and saturation:

∂ₜxᵢ(t)=(−1+p)x′ᵢ(t)−x′ᵢ(t)³

### (S4).

The operations in step S3 and S4 can be done in parallel or in any order.

Then, the data processor 1 calculates an injection term (S5) by summing injections:

$${I}_{i}^{( 0 )} = - {ϵ}_{0} {e}_{i}^{( 0 )} {h}_{0} \\ {I}_{i}^{( k )} = - {ϵ}_{k} {e}_{i}^{( k )} {h}_{k} \\ as \\ {\partial }_{t} {x}_{i} ( t ) = ( - 1 + p ) {x}_{i} ( t ) - {x}_{i}^{3} ( t ) + {\sum }_{k} {I}_{i}^{( k )} , \qquad$$

and updates state data (S6):

xᵢ(t+dt)=xᵢ(t)+∂ₜxᵢ(t)dt.

The data processor 1 applies projection to the state data xᵢ(S7), and calculates a current error (current loss; S8).

Then the data processor 1 checks if a predetermined condition is satisfied to determine whether the iteration process should finish or not (S9). Here, one of the examples of the predetermined condition may be a time budget. In this example, the data processor 1 decides whether the time consumed by the iteration excesses the predetermined time limit or not. The data processor 1 then repeats the calculation from the step S1 if the time consumed by the iteration does not excess the predetermined time limit (S9:No), otherwise (S9:Yes), the data processor 1 outputs the result of the calculation (state data xᵢ or its acceptable Boolean configuration σ) as the best configuration found (S10), and finish the process.

For showing an operation of the data processor of the embodiment, some specific examples for solving problems will be described below.

### (1) Example of the Maximum Cut Problem

The proposed architecture used in the max-cut problem will be illustrated. The data processing apparatus 1 for the max-cut problem is configured to find the cut of the graph defined by the weights

{ωᵢⱼ}ᵢⱼ
for which the sum over the weights is maximal. Here i and j are one of the natural numbers below N: 1, 2, . . . , N.

A given solution for the max-cut problem can be represented by a partition of the vertices i, into two sets obtained after the cut. The belonging of the vertex i to one or the other set is encoded by a Boolean variable

σᵢ.
The optimal solution of the problem, or max-cut, is the one that minimizes the cost function

$$- {V}^{( 0 )} ( σ ) \\ where {V}^{( 0 )} ( σ ) = - \frac{1}{2} ( ℋ + \frac{1}{2} {\sum }_{i j} {ω}_{i j} ) , \\ where \\ ℋ \qquad$$

### is the Ising Hamiltonian:

$$ℋ = - \frac{1}{2} {\sum }_{i j} {ω}_{i j} {σ}_{i} {σ}_{j} ,$$

and σ is the vector of which the elements are σᵢ (i=1, 2, . . . ).

The max-cut problem is a quadratic unconstrained binary combinatorial optimization problem, or Ising problem. Note that the parameters of the cost function consist of the matrix, and the total cost function V* consists of only one matrix:

M₀₁=Ω={ωᵢⱼ}ᵢⱼ.

So, the objective function is simply given as:

V*=V⁽⁰⁾.

In the case of the max-cut problem, there are no constraints. Thus, the data processor for this example has only N state data processors 21 which correspond to state data xᵢ (i=1, 2, . . . , N). The data processor for this example also requires only N error calculation units 23 which correspond to the error data eᵢ⁽⁰⁾ for correcting the amplitude heterogeneity when solving the problem of size N.

In this example, the valid subspace is the whole configuration, and so the projection operator P is identity:

x′=x.

In addition to that, the conversion to acceptable solution is achieved by defining:

C[xᵢ]=sign(xᵢ),

where sign(x)=1 if x>0, and sign(x)=−1 otherwise.

In this example, in the processor 11 of this embodiment, the state data processor 21 initializes the state data xᵢ (i=1, 2, . . . N) by a predetermined method, for example, by generating a random Boolean value for xᵢ.

Once the state data is set, the cost evaluation unit 22 evaluates a cost function for current state data. In this example, the cost function is set to

$${V}^{( 0 )} ( x ) = - \frac{1}{2} ( ℋ + \frac{1}{2} {\sum }_{i j} {ω}_{i j} ) \qquad$$

where the Hamiltonian is the Ising Hamiltonian:

$$ℋ = - \frac{1}{2} {\sum }_{ij} {ω}_{i j} {x}_{i} {x}_{j}$$

$$and$$

$${\{ {ω}_{i j} \}}_{i j}$$

is the weight which is initialized randomly at the first time of iteration.

Meanwhile, the error calculation unit 23 calculates error values relating to amplitude homogeneity of the current state data.

The time-evolution processor 2311 of the error calculation unit 23 takes a target amplitude a (a>0) and a rate of change of error values β, which are initially (at t=0) set to predetermined values, such as a=1.0 and β(t=0)=0.0.

Taking advantage of these values, the time-evolution processor 2311 calculates the time-evolution of the error values eᵢ⁽⁰⁾

∂ₜeᵢ⁽⁰⁾=−β(t)[xᵢ²−a]eᵢ⁽⁰⁾,

wherein the error values eᵢ⁽⁰⁾ for the first time of iteration are set to random numbers.

The updater 2312 updates the current error values eᵢ⁽⁰⁾ by adding ∂ₜ eᵢ⁽⁰⁾dt to get updated error values eᵢ⁽⁰⁾, and outputs the updated error values eᵢ⁽⁰⁾ to the state data processor 21.

Then, the gain-dissipative simulator 211 of the state data processor 21 gets the state data xᵢ, a linear gain p, and the error values eᵢ⁽⁰⁾ to calculate the time-evolution of the state as:

∂ₜxᵢ=(−1+p)xᵢ−xᵢ³+∈eᵢ⁽⁰⁾Σ_{j≠i}ωᵢⱼxⱼ.

In this formula, the time dependency is not explicitly shown, but the values such as the state data xᵢ and the error values eᵢ⁽⁰⁾ change depending on time t.

The state data processor 21 updates the state data by adding the corresponding state data xᵢ and the time-evolution of the state data:

xᵢ(t+dt)=xᵢ(t)+∂ₜxᵢ(t)dt.

The state data processor 21 stores the updated state data xᵢ(t+dt) as the current state data. It must be noted that in this problem, there are no soft constraints of type I, the projection P is the identity operator, and the vector x′ is equal to the vector x:

x′=x,

and the updated state data is stored as the current state data in the next iteration as they are.

Before the next iteration of updating the state data, the modulation unit 24 performs calculation of parameter values such as a linear gain p, a target amplitude a, and a rate of change of error values β based on the current state data.

The modulation unit 24 converts the state data x into an acceptable Boolean configuration σ. In this example, since the state data x is already Boolean values, the modulation unit 24 calculates the current value of the cost function V⁽⁰⁾, and the modulation unit 24 modulates the linear gain p and the target amplitude a as represented by formulae (12) and (13):

a=α+ρ₁ϕ(δΔV⁽⁰⁾)

p=π+ρ₂ϕ(δΔV⁽⁰⁾),

and the rate
β₀
is also modulated in the same manner.

In the formulae,

ΔV⁽⁰⁾=Vₒₚₜ⁽⁰⁾−V⁽⁰⁾(t),

and the function
ϕ
is a sigmoidal function, and
ρ₁>0
ρ₂>0
δ>0
are constant predetermined parameters.

The Parameter values

α,π
are predetermined by the user.

Here, V⁽⁰⁾ (t) is the value of the cost function associated with the state data x(t) which is evaluated by the cost evaluation unit 22, and Vₒₚₜ⁽⁰⁾ is the target energy. In this example, Vₒₚₜ⁽⁰⁾ is set to the lowest energy found during the iterative computation:

$${V}_{o p t}^{( 0 )} {min}_{{t}^{′} \leq t} {V}^{( 0 )} ( {t}^{′} ) . \qquad$$

For obtaining the Vₒₚₜ⁽⁰⁾, the modulation unit 24 memorizes the current Vₒₚₜ⁽⁰⁾, and updates the Vₒₚₜ⁽⁰⁾ when the current V⁽⁰⁾ (t) is lower than the memorized Vₒₚₜ⁽⁰⁾. At the initial state, since the modulation unit 24 does not memorize any Vₒₚₜ⁽⁰⁾, the modulation unit 24 simply memorizes a calculated V⁽⁰⁾ (t=0).

The modulation unit 24 gets the updated linear gain p, the target amplitude a, and the rate

β₀,
and outputs those.

The processor 11 outputs the current updated state data x and the cost function, and then proceeds to the next iteration step.

The cost evaluation unit 22 evaluates the cost function for current (updated) state data, and the error calculation unit 23 calculates the error values relating to the amplitude homogeneity of the current state data.

The processor 11 iterates the process, that is, the processor 11 calculates the time-evolution of error values:

∂ₜeᵢ⁽⁰⁾=−β(t)[xᵢ²−a]eᵢ⁽⁰⁾,

time-evolution of the state data:

∂ₜxᵢ=(−1+p)xᵢ−xᵢ³+∈eᵢ⁽⁰⁾Σ_{j≠i}ωᵢⱼxⱼ,

and update the error values as:

eᵢ⁽⁰⁾(t+dt)=eᵢ⁽⁰⁾(t)−β(t)[xᵢ²−a]eᵢ⁽⁰⁾(t)dt,

and update the state data as:

xᵢ(t+dt)=xᵢ(t)+∂ₜxᵢ(t)dt.

The processor 11 stores the updated state data x₁(t+dt) as the current state data.

And then, the processor 11 performs calculation of parameter values such as a linear gain p, a target amplitude a, and a rate of change of error values βₖ, based on the current state data.

The processor 11 outputs the current updated state data x and the cost function, and repeats the process until the cost function satisfies a predetermined condition, such that the cost function is lower than a predetermined threshold, or until the user stops the process.

In the case of the max-cut problem, the dynamics of the data processing apparatus 1 can be summarized as follows:

∂ₜxᵢ=(−1+p)xᵢ−xᵢ³+∈eᵢ⁽⁰⁾Σ_{j≠i}ωᵢⱼxⱼ (15)

∂ₜeᵢ⁽⁰⁾=−β(t)[xᵢ²−a]eᵢ⁽⁰⁾. (16)

These equations are obtained from calculating the gradient of

### −V⁽⁰⁾(x).

Moreover, the target amplitude a is chosen as follows in order to assure the convergence to the optimal solution:

$$a ( Δ𝒞 ) = α + ρ f ( δΔ𝒞 ) , \\ where \\ Δ𝒞 = - {𝒞}_{o p t} + 𝒞 ( t ) , \\ 𝒞 ( t ) = - \frac{1}{2} ( ℋ ( t ) + \frac{1}{2} {\sum }_{ij} {ω}_{i j} ) , and \\ {𝒞}_{o p t} = - \frac{1}{2} ( {ℋ}_{o p t} + \frac{1}{2} {\sum }_{ij} {ω}_{i j} ) . \\ Here , \\ ℋ ( t ) \qquad ( 17 )$$

is the Ising energy of the current configuration (current state data), and [symbol]
ₒₚₜ
is the target energy. In practice, the target energy can be set to the lowest energy found:

$${ℋ}_{opt} ( t ) = {min}_{{t}^{′} \leq t} ℋ ( {t}^{′} ) ,$$

or can be set to the ground state energy if it is known.

Moreover, the function f is a sigmoidal function and both

ρ,δ
are positive non-zero constant parameters which are preset by the user.

For further shortening of the time-to-solution, it is considered that the parameter

β
is time-dependent. It is linearly increased with a rate equal to
λ
during the simulation, and reset to zero if the energy does not decrease during a duration
τ
which is a positive value.

If

t−t_{c}<τ,

where, t_{c} represents the time when the best known energy [symbol]
ₒₚₜ
is the lowest or when
β
is reset;
the dynamics of
β(t)
is given by:

∂ₜβ(t)=λ (18)

where
β(0)=0.
On the other hand,
if

t−t_{c}≥τ;

β
is set to 0 and t_{c} is set to t.

Lastly, the parameter p, the linear gain, is made state-dependent as:

p(Δ [symbol] )=π+ρƒ(δΔ [symbol] ). (19)

(2) Example of the Quadratic Assignment Problem (QAP)

The quadratic assignment problem (QAP) consists in assigning n factories at n different sites, such that the total cost of sending commodities, equal to the sum of distances and times flows between factories, is minimized. In order to encode this problem in an objective function, Boolean variables sᵢᵤ will be defined such that sᵢᵤ=1 if the factory u is assigned to the site i; sᵢᵤ=0, otherwise. Then, solving this problem consists in finding a configuration that minimizes the following cost function V⁽⁰⁾:

$${V}^{( 0 )} = {\sum }_{i j v u} {a}_{i j} {b}_{u v} {s}_{i u} {s}_{jv} . . . + \frac{1}{q} [ {\sum }_{i} {( 1 - {\sum }_{u} {s}_{iu} )}^{2} + {\sum }_{u} {( 1 - {\sum }_{i} {s}_{iu} )}^{2} ] \qquad ( 20 )$$

where the matrix {bᵤᵥ}ᵤᵥ (whose (u,v)-th element is bᵤᵥ) represents flows between factories u and v, and the matrix {aᵢⱼ}ᵢⱼ (whose (i,j)-th element is aᵢⱼ) represents distance between sites i and j.

Note that the traveling salesman problem is a special case of QAP.

By considering the change of variable σᵢ=2(sᵢ−0.5), this objective function can be mapped to the following cost function:

$${V}^{*} = {V}^{( 0 )} + \frac{1}{q} ( {U}^{( 1 )} + {U}^{( 2 )} ) \qquad ( 21 )$$

where V⁽⁰⁾ is the cost function to be minimized, U⁽¹⁾ and U⁽²⁾ are soft constraints of type I related the first constraint (one factory per site) and second constraint (one site par factory), respectively. Moreover, q is a positive parameter predetermined by the user. Each cost function can be expressed as:

$$- \frac{1}{2} {\sum }_{ijuv} {ω}_{i j u v}^{( k )} {σ}_{i u} {σ}_{jv} - {\sum }_{iu} {θ}_{i u}^{( k )} {σ}_{i u}$$

for k=1, 2, 3. The Ising coupling and Zeeman terms are:

$${Ω}^{( 0 )} = \frac{1}{4} A ⊗ B \\ {Ω}^{( 1 )} = - \frac{1}{4} I ⊗ \\ {Ω}^{( 2 )} = - \frac{1}{4} ⊗ I \\ {Θ}^{( 0 )} = 2 {Ω}^{( 0 )} \\ {Θ}^{( 1 )} = \frac{N - 2}{2} \\ {Θ}^{( 2 )} = \frac{N - 2}{2} \\ Here , \\ \qquad ( 22 )$$

is the matrix of size

### N×N

whose components are all 1, and

[symbol]

is the vector of size N whose components are all 1.

The A and B are matrices whose components are aᵢⱼ and bᵢⱼ respectively, and I is the identity matrix of size

### N×N.

Note that the Thing coupling is the cost function for this problem, and the parameters of the cost function depend on the tensor products of the matrices.

The parameters characterizing the cost functions are:

$${M}_{01} = \frac{A}{2}$$

$${M}_{02} = \frac{B}{2}$$

$${M}_{03} = {Θ}^{( 0 )} .$$

Moreover, the parameters characterizing the first and second constraints are:

$${M}_{11} = \frac{I}{2}$$

$${M}_{12} = \frac{2}{}$$

$${M}_{13} = {Θ}^{( 1 )}$$

$$and$$

$${M}_{21} = - \frac{2}{}$$

$${M}_{22} = \frac{I}{2}$$

$${M}_{23} = {Θ}^{( 2 )} .$$

In the case of QAP, all constraints are considered as type I. Thus the processor 11 is configured to have N state data processors 21 for state data xᵢ, and to have N error calculation units 23 for e⁽⁰⁾ᵢ for correcting the amplitude heterogeneity when a problem to be solved has the size N. Moreover, the cost function V* is given as described as equation (21). The valid subspace for this problem is defined as:

$$x ∈ {X}_{a} ⇔ \{ \begin{matrix}{Σ}_{i} {x}_{iu} = {C}_{a} , \\ {Σ}_{u} {x}_{iu} = {C}_{a} .\end{matrix} \qquad ( 23 )$$

Here, Xₐ is the real space of dimension N, and Cₐ is a constant defined such that

$$〈 \vert x \vert 〉 = \frac{1}{N} {\sum }_{i , u} \vert {x}_{i u} \vert = \frac{\sqrt{a} ( 2 - \sqrt{N} )}{\sqrt{N}} .$$

The valid subspace is thus the set of stochastic matrices {xᵢᵤ}ᵢᵤ.

The projection operator P on the valid subspace can be determined by considering the eigendecomposition of the matrix

Ω⁽¹⁾+Ω⁽²⁾.

The conversion to acceptable solutions is achieved by associating a permutation matrix with each state data matrix {xᵢᵤ}ᵢᵤ.

In this example, in the processor 11 of this embodiment, the state data processor 21 initializes the state data xᵢ (i=1, 2, . . . N) by a predetermined method, for example, by generating state data for one of allowed state (as a state data is in the valid subspace).

Here, the state data xᵢ represents Boolean variables s_{pq} such that s_{pq}=1 if the factory q is assigned to the site p; s_{pq}=0, otherwise; where i=Nₛᵢₜₑ(p−1)+q; Nₛᵢₜₑ is the number of sites.

The Projection unit 212 of the state data processor 21 performs projection of the current state data onto a predetermined valid subspace. Specifically, in this example, the state data vector x is projected onto the valid subspace using a projection operator P which is predetermined according to the constraints of type I to get x′. the projection operator P can be determined by considering the eigendecomposition of the matrix

Ω⁽¹⁾+Ω⁽²⁾,

where
Ω⁽¹⁾,Ω⁽²⁾
are defined as equation (22).

Once the state data is set, the cost evaluation unit 22 evaluates a cost function for current state data. In this example, the cost function V* is set to equation (21).

Meanwhile, the error calculation unit 23 calculates error values relating to amplitude homogeneity of the current state data.

The time-evolution processor 2311 of the error calculation unit 23 takes a target amplitude a (a>0) and a rate of change of error values β, which are initially (at t=0) set to predetermined values, such as a=1.0 and β(t=0)=0.0.

Taking advantage of these values, the time-evolution processor 2311 calculates the gradient of the error values eᵢ⁽⁰⁾ as

∂ₜeᵢ⁽⁰⁾(t)=−β₀(t)[x′ᵢ(t)²−a]eᵢ⁽⁰⁾(t)

wherein the error values eᵢ⁽⁰⁾ (t=0) for the first time of iteration are set to predetermined values.

The updater 2312 updates the current error values eᵢ⁽⁰⁾ (t) by adding ∂ₜeᵢ⁽⁰⁾ (t) dt to get updated error values eᵢ⁽⁰⁾ (t+dt), the error values for next iteration, and outputs the updated error values eᵢ⁽⁰⁾ (t+dt) to the state data processor 21:

eᵢ⁽⁰⁾(t+dt)=eᵢ⁽⁰⁾(t)−β(t)[x′ᵢ(t)²−a]eᵢ⁽⁰⁾(t)dt.

Then, the gain-dissipative simulator 211 of the state data processor 21 gets the state data x′ᵢ (the state data projected onto the valid subspace), a linear gain p, and the error values eᵢ⁽⁰⁾ to calculate the time-evolution of the state as:

∂ₜxᵢ(t)=(−1+p)x′ᵢ(t)−x′ᵢ(t)³+∈₀eᵢ⁽⁰⁾(t)hᵢ⁽⁰⁾(t).

Here, h⁽⁰⁾ᵢ(t) is the i-th element of the vector h⁽⁰⁾(t) which is defined as:

$${h}^{( 0 )} ( t ) = [ {Ω}^{( 0 )} + \frac{1}{q} ( {Ω}^{( 1 )} + {Ω}^{( 2 )} ) ] {x}^{′} + {μ}_{{x}^{′}} , \\ where \\ Θ = {Θ}^{( 0 )} + \frac{η}{q} ( {Θ}^{( 1 )} + {Θ}^{( 2 )} ) , \qquad ( 24 )$$

and both q and η are constant positive parameters: q>0, η>0. The value h⁽⁰⁾ᵢ(t) is calculated with M₀ᵢ, M₁ᵢ, M₂ᵢ, and the state data x′ᵢ (the state data projected onto the valid subspace).

The term

μ_{x′}
is, in simple cases, equal to [symbol]
|x′|

[symbol]
which represents the average absolute amplitude of x′ᵢ, i.e.:

$$〈 \vert x ' \vert 〉 = \frac{1}{N} {\sum }_{i} \vert {x}_{i}^{′} \vert ,$$

in other than simple cases, the term
μ_{x′}
can be taken to be equal to

$${μ}_{{x}^{′}} = \frac{1}{N} {\sum }_{i} log \frac{( cosh ( ζ {x}_{i}^{′} ) )}{ζ} , \\ where$$

$$ζ$$

is a parameter which is, for example, empirically set, from where
ζ>1.

The state data processor 21 updates the state data by adding corresponding state data xᵢ and the gradient descent:

xᵢ(t+dt)=xᵢ(t)+∂ₜxᵢ(t)dt.

The state data processor 21 stores the updated state data xᵢ(t+dt) as the current state data. It must be noted that in this problem, there are soft constraints of type I, and the Projection unit 212 of the state data processor 21 performs projection of the updated state data x using the projection operator P:

x′ᵢ(t+dt)=P[xᵢ(t+dt)].

The projected state data xᵢ′(t+dt) is stored as the current state data x(t) in the next iteration.

Before the next iteration of updating state data, the modulation unit 24 performs calculation of parameter values such as a linear gain p, a target amplitude a, and a rate of change of error values β₀ based on the current state data.

The modulation unit 24 converts the state data x into an acceptable Boolean configuration σ by a formula such as σ_{pq}=2(s_{pq}−0.5), and the acceptable configuration respects the constraints of the quadratic assignment problem, i.e.,

Σₚs_{pq}=1,∀g and Σ_{q}s_{pq}=1,∀p.

The modulation unit 24 calculates the current value of one of the terms of the cost function V⁽⁰⁾, and the modulation unit 24 modulates the linear gain p and the target amplitude a as represented by formulae (12) and (13):

a=α+ρ₁ϕ(δΔV⁽⁰⁾) (12)

p=π+ρ₂ϕ(δΔV⁽⁰⁾), (13)

and the rate
β₀
is also modulated in the same manner.

In the formulae,

ΔV⁽⁰⁾>=Vₒₚₜ⁽⁰⁾−V⁽⁰⁾(t),

and the function
ϕ
is a sigmoidal function, and
ρ₁>0
ρ₂>0
δ>0
are constant predetermined parameters.

The Parameter values

α,π
are predetermined by the user.

Here, V⁽⁰⁾ (t) is the value of one of the term of the cost function associated with the state data x(t) which is evaluated by the cost evaluation unit 22, and Vₒₚₜ⁽⁰⁾ is the target energy. In this example, Vₒₚₜ⁽⁰⁾ is set to the lowest energy found during the iterative computation:

$${V}_{o p t}^{( 0 )} = {min}_{{t}^{′} \leq t} {V}^{( 0 )} ( {t}^{′} ) . \qquad$$

For obtaining the Vₒₚₜ⁽⁰⁾, the modulation unit 24 memorizes the current Vₒₚₜ⁽⁰⁾, and updates the Vₒₚₜ⁽⁰⁾ when the current V⁽⁰⁾ (t) is lower than the memorized Vₒₚₜ⁽⁰⁾. At the initial state, since the modulation unit 24 does not memorize any Vₒₚₜ⁽⁰⁾, the modulation unit 24 simply memorizes a calculated V⁽⁰⁾ (t=0).

The modulation unit 24 gets the updated linear gain p, the target amplitude a, and the rate

β₀,
and outputs those.

The processor 11 outputs the current updated state data x and the cost function, and then proceeds to the next iteration step.

In the case of QAP, as shown above, the dynamics of the data processing apparatus 1 can be summarized as:

xᵢₐ(t+dt)=x′ᵢₐ(t)+[(−1+p)x′ᵢₐ(t)−x′ᵢₐ(t)³]dt+[∈₀eᵢₐ⁽⁰⁾(t)hᵢₐ⁽⁰⁾(t)]dt (25)

eᵢₐ⁽⁰⁾(t+dt)=eᵢₐ⁽⁰⁾(t)−β₀(t)[x′ᵢₐ(t)²−a]eᵢₐ⁽⁰⁾(t)dt (26)

and

x′ᵢₐ(t)=P[xᵢₐ(t)] (27)

In the formulae, indices i,a represents i-th factory and a-th site, and here, the h⁽⁰⁾ᵢₐ is defined as formulae (24)

Although the calculation of h⁽⁰⁾ includes matrix vector multiplications, such as

Ω⁽⁰⁾x,
since the matrix size is N² by N², products of them are not computed directly in practice. Rather, the result of the products is computed by taking into account the fact that the matrices themselves are the results of tensor products.

For example,

Ω⁽⁰⁾∝A⊗B.

So the products are computed as following:

(A⊗B)x=[A{xᵢᵤ}ᵢᵤB′]

wherein the [Q] represents a vector whose elements are those of Q.

(3) Architecture Proposing Using the Lead Optimization Problem

The lead optimization problem is a problem to find a structure of compound candidate given that its geometry and constituting atomic species are known. That is, the objective of this combinatorial optimization problem is to assign atomic species to positions of the known geometry in order to minimize interaction energy with a given protein.

If the spatial structure has, for example, the form —X1-X2-X3-X4-X5-X6- with σᵢₙ can be chosen among ═CH—, ═CH2, ═O, ═NH2, —OH, —CH3, (wherein each symbol “=” or “−” represents chemical bond) then a possible solution is the chain —CH═CH—CH═CH-CH═CH—.

Candidate structures must satisfy two constraints: (1) the consistency between bonds of neighboring species must be satisfied, (2) only one atomic species can be assigned per position. In the following, the scope of this problem is restricted to finding candidate species that satisfy these two constraints, without taking into account interaction energies with the target protein, for the sake of simplicity.

The proposed architecture can be used to solve such constrained combinatorial optimization problem. First, state-encoding variables σᵢₙ=±1 are considered which encode, when σᵢₙ=1, for having the atomic species n active at the site i; otherwise σᵢₙ=−1. The two constraints described here-above can be converted into a Ising problem with cost function V given as follows:

V*=α₁V⁽¹⁾+α₂V⁽²⁾ (28)

(according to H. Sakaguchi, et. al., “Boltzmann Sampling by Degenerate Optical Parametric Oscillator Network for Structure-Based Virtual Screening”, Entropy, 18, 365(2016)), where V⁽¹⁾ and V⁽²⁾ are cost functions of soft constraints related to the first constraint, which represents bond consistency, and the second constraint, which represents unicity, respectively.

Specifically,

$$\begin{matrix}{V}^{( 1 )} = - \frac{1}{2} {\sum }_{injm} {ω}_{injm}^{( 1 )} {σ}_{i n} {σ}_{jm} - {\sum }_{in}^{ } {θ}_{i n}^{( 1 )} {σ}_{i n} & ( 29 ) \\ {V}^{( 2 )} = - \frac{1}{2} {\sum }_{injm} {ω}_{i n j m}^{( 2 )} {σ}_{i n} {σ}_{j m} - {\sum }_{in} {θ}_{i n}^{( 2 )} {σ}_{in} . & ( 30 )\end{matrix}$$

In these formulae,

ωᵢₙⱼₘ⁽¹⁾,θᵢₙ⁽¹⁾,ωᵢₙⱼₘ⁽²⁾, and θᵢₙ⁽²⁾

are the parameters defined by the user with considering the change of the variable

$${s}_{i} = \frac{{σ}_{i} + 1}{2}$$

which may be 0 or 1.

Finding a satisfiable structure is equivalent to minimizing the cost function V*.

In reality, the cost functions V⁽¹⁾ and V⁽²⁾ of soft constraints are also written as:

$$\begin{matrix}{V}^{( 1 )} = {\sum }_{injm} {J}_{i n j {m}^{S} i {n}^{S} j m} + {C}_{1} & ( 31 ) \\ {V}^{( 2 )} = {\sum }_{i} {( {\sum }_{n} {s}_{i n} - 1 )}^{2} + {C}_{2} . & ( 32 )\end{matrix}$$

Here, if the sites i and j are adjacent, and the bonds of the atomic species n at position i are not compatible with the ones of atomic species m at position j, Jᵢₙⱼₘ=1.

On the other hand, if the sites i and j are not adjacent, or the bonds of the atomic species n at position i are compatible with the ones of atomic species m at position j, Jᵢₙⱼₘ=0.

C₁ and C₂ are constant values that are independent of sᵢₙ and do not matter for the combinational optimization problem.

Since the operation of the data processing apparatus 1 will be in the same manner as described in the examples of max-cut and QAP, the redundant explanation will be omitted.

In this example, the data processing apparatus 1 may be configured to operate on the following dynamics:

∂ₜxᵢₙ=(−1+p)xᵢₙ−xᵢₙ³ . . . +∈₁[eᵢₙ⁽¹⁾μᵢₙ⁽¹⁾+θᵢₙ⁽¹⁾]+∈₂[eᵢₙ⁽²⁾μᵢₙ⁽²⁾+θᵢₙ⁽²⁾] (33)

∂ₜeᵢₙ⁽¹⁾=β₁gᵢₙ⁽¹⁾(σ,eᵢₙ⁽¹⁾) (34)

∂ₜeᵢ⁽²⁾=β₂gᵢ⁽²⁾(σ,eᵢ⁽²⁾). (35)

The formulae (34) represents bond consistency, and the formulae (35) represents unicity.

Here,

$${μ}_{i n}^{( 1 )} = {\sum }_{j m} {ω}_{injm}^{( 1 )} {x}_{jm}$$

$${μ}_{i n}^{( 2 )} = {\sum }_{j m} {ω}_{injm}^{( 2 )} {x}_{jm}$$

$${g}_{in}^{( 1 )} ( σ , {e}_{i n}^{( 1 )} ) = 1 + {E}_{i n} ( \{ σ \} ) - {e}_{i n}^{( 1 )}$$

$${g}_{i}^{( 2 )} ( σ , {e}_{i}^{( 2 )} ) = - ( {\sum }_{m} \frac{1}{2} ( {σ}_{i m} + 1 ) - 1 ) {e}_{i}^{( 2 )} ,$$

and Eᵢₙ>0 when atom n at position i is inconsistent.

β₁

and
β₂
are change rates of error values for eᵢₙ⁽¹⁾ and eᵢ⁽²⁾, respectively.

The

β₁
and
β₂
may be different each other.

Another aspect of this embodiment is described below.

The state data in the state data processor 21 may be described by quantum dynamics. In this arrangement, each unit of the state data processor 21, for each state data xᵢ, may hold the state data as a density matrix ρᵢ, and the dynamics of isolated units by a quantum master equation. In the most general case, when this density matrix cannot be written as a tensor product of smaller density matrices, a single density matrix ρᵢ₁ᵢ₂ . . . can describe the state of multiple units i₁, i₂, . . . .

The state data can be encoded in three different ways:

(1) by a density matrix at the quantum level,
(2) by an analog variable at the classical level, and
(3) by a Boolean state at the logical level.

The conversion from quantum to classical description is performed by a quantum measurement. The conversion from analog to Boolean by an analog-to-digital converter.

Specifically, the state data processor 21 can be implemented by using an Ising model quantum computation device such as a DOPO (Degenerate Optical Parametric Oscillator) shown in US2017/0024658A1.

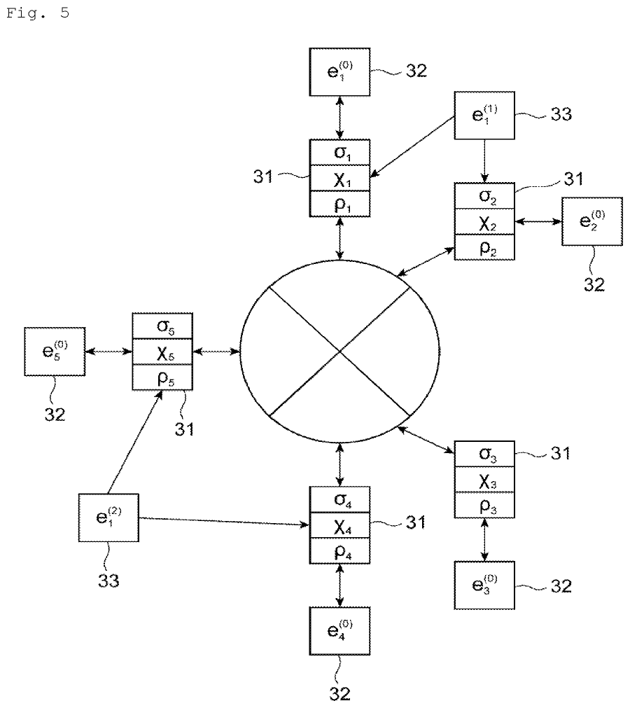

In FIG. 4, a coherent Ising machine(CIM) based degenerate optical parametric oscillator (DOPO) according to P. L. McMahon, et al., “A fully-programmable 100-spin coherent Ising machine with all-to-all connections”, Science 354, 614 (2016) is shown.

Since the detail of the DOPO system is shown in US2017/0024658A1, the basic structure of the DOPO will be shown here. The state data processor 21 implemented by using the DOPO system is shown in FIG. 4. The state data processor 21 in this example includes a Pump Pulse Generator(PPG) 41, a Second Harmonic Generation Device(SHG) 42, a Periodically-poled Wave Guide Device(PPWG) 43, Directional Couplers 44, an AD Converter 45, an FPGA device 46, a DA Converter 47, a Modulator 48, a Ring Cavity 49.

In this system plurality of pump pulse light wave (pseudo spin pulses) are generated by the PPG41 and the SHG 42 and are introduced into the Ring Cavity 49 via the PPWG 43 in the time-divisional manner.

Here, the plurality of the pseudo spin pulses are in correspondence with a plurality of Ising model spins in a pseudo manner and having mutually an identical oscillation frequency.

The time between the adjacent light waves T is set to the L/c/N where L is the length of the Ring Cavity 49, c is the light speed travelling through the Ring Cavity 49, and N is a natural number N>0.

A part of the light wave travelling through the Ring Cavity (a ring resonator) 49 is guided via the first Directional Coupler 44-1 into the AD Converter 45. Hereinafter, the other part of the light wave which continues to travel in the Ring Cavity 49 to the second Directional Coupler 44-2 is called as “target wave.”

The AD Converter 45 converts the strength of the light wave introduced into a digital value, and outputs the value into the FPGA device 46.

In other words, the first Directional Coupler 44-1 and the AD Converter 45 a tentatively measure phases and amplitudes of the plurality of pseudo spin pulses every time the plurality of pseudo spin pulses circularly propagate in the Ring Cavity 49.

The FPGA device 46 in the DOPO system may be configured as adding AD converter 45's output (which represents previous state data xᵢ(t)) to

∂ₜx
calculated using outputs from a cost evaluation unit 22, an error calculation unit 23, and modulation unit 24.

The FPGA device 46 outputs the result of the addition to the DA converter 47 whose output will be used to modulate input pulse.

The Modulator 48 generates other pump pulse light wave and modulate amplitude and phase of the light wave with output of DA converter 47 which is the analog value corresponds to the output of FPGA device 46. For example, the Modulator 48 delays the phase by π/2 when

∂ₜx
is positive and performs amplitude modulation proportional to the absolute value of
∂ₜx, and the Modulator 48 advances the phase by π/2 when
∂ₜx
is negative and performs amplitude modulation proportional to the absolute value of
∂ₜx.

The modulated light wave produced by the Modulator 48 is guided into the Ring Cavity 49 via the second Directional Coupler 44-2. Note that the second Directional Coupler 44-2 introduces the modulated light into the Ring Cavity 49 at the timing of the target wave is coming to the second Directional Coupler 44-2, so that the light waves are synthesized, and the pseudo spin pulse.

As shown in the above, in this example, the FPGA device 46 outputs the value which represents

xᵢ(t+dt)=xᵢ(t)+∂ₜxᵢ(t)dt.

The synthesized light wave is guided along the Ring Cavity 49, and the FPGA device 46 repeatedly outputs the value which represents the progress of the state data xᵢ(t).

So the DOPO system works as a gain-dissipative simulator 211. The output of the FPGA device 46 of this DOPO system is introduced not only into the DA Converter 47, but also into other part of the state data processor 21 such as the projection unit 212 and the like.

Since the operation of DOPO is well known, further detail description will be omitted here.

In other aspect of the embodiment of the present invention, the data processing apparatus 1 may be constructed from a digital processor such as CPU. In this aspect, the state data processor 21, the cost evaluation unit 22, the error calculation unit 23, and the modulation unit 24 are realized as a software program which is executed on the CPU. The program may be installed in the memory device connected to the CPU, and the memory device may store data which CPU uses, the data begin such as state data, error values or the like. The aspect of this embodiment may be realized with a generic computer device which also includes a display device and an input device such as a keyboard, and the like.

In other aspect of the embodiment of the present invention, the data processing apparatus 1 may be constructed from a digital processor such as FPGA, GPU, and the like. In this aspect, the state data processor 21, the cost evaluation unit 22, the error calculation unit 23, and the modulation unit 24 are realized as a design implementation in terms of logic gates which are obtained after a synthesis process. The aspect of this embodiment can be interfaced with a generic computer device which includes also display device and an input device such as keyboard, and the like.

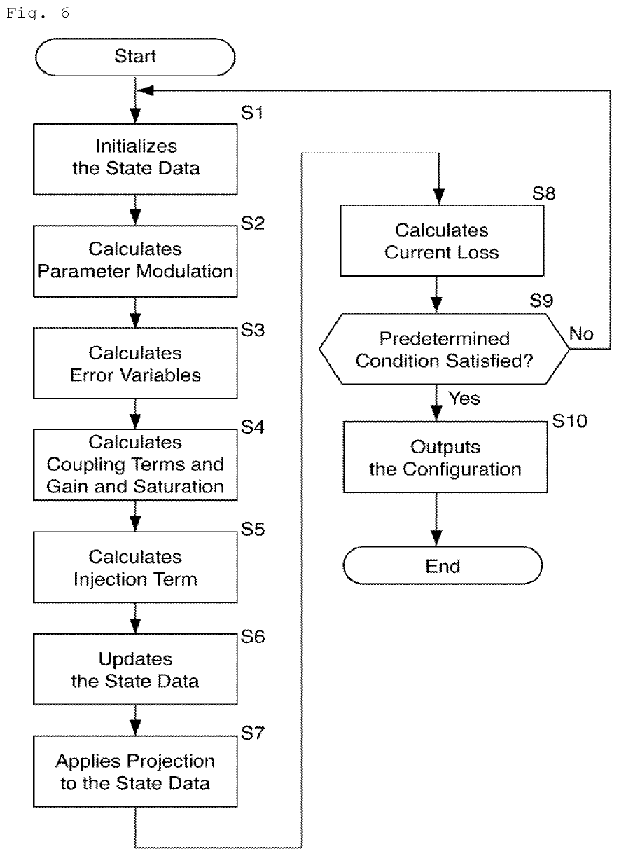

In FIG. 5 shows the schematic functional structure according to an embodiment of the present invention. As shown in the FIG. 5, the data processing apparatus 1 according to one aspect of the embodiment of the present invention includes state data nodes 31, first-order error nodes 32, and higher-order error nodes 33.

The state data nodes 31 holds state data which is denoted by selected from a Boolean value

σᵢ,
an analog value xi, and a quantum representation (density matrix)
ρᵢ.

The state data nodes are connected each other, and a value which is held in one state data node affects the values which are held in other state data nodes, via cost function V*.

Each one of the first-order error nodes 32 is connected to a corresponding state data node 31. The first-order error nodes 32 corrects the state data which is held in the corresponding state data node 31 to correct amplitude inhomogeneity of the state data.

The higher-order error nodes 33 is connected to at least one of the state data nodes 31. Some of state data nodes 31 may not connected to the higher-order error nodes 33. In other words, the connection between the high-order error nodes 33 and the state data nodes 31 is “asymmetrical.” The connection between the high-order error nodes 33 and the state data nodes 31 is defined by the problem to be solved. The higher-order error nodes 33 may change the state data which is/are held in the state data node(s) 31 connected in order to force the constraint of the problem to be solved onto the state data.

Although only some exemplary embodiments have been described in detail above, those skilled in the art will readily appreciate that many modifications are possible in the exemplary embodiments without materially departing from the novel teachings and advantages. Accordingly, all such modifications are intended to be included within the scope.

What is claimed is:

1. A data processing apparatus which is configured to solve a given problem comprising:
a state data processing unit configured to iterate update of state data by a predetermined time evolutional process;
a cost evaluation unit configured to evaluate a cost function for current state data; and
an error calculation unit configured to calculate error values relating to amplitude homogeneity of the current state data;
wherein the state data is a set of variables, and the state data processing unit performs the time evolutional process on the state data to update the current state data based on the cost function and the error values which are relating to amplitude homogeneity of the current state data calculated by the error calculation unit.

2. The data processing apparatus according to claim 1,
the state data processing unit performs the time evolutional process on the state data to update current state data based on a gradient of the cost function and the error values.

3. The data processing apparatus according to claim 2,
the time evolutional process on the state data also updates the current state data based on an archetype potential that is changed from monostable to bistable according to the gain value based on the current state data.

4. The data processor apparatus according to claim 1,
wherein the error calculation unit is also configured to calculate at least one error value relating to constraints of a problem to be solved.

5. The data processing apparatus according to claim 1,
wherein the state data processing unit also performs projection of the state data onto a predetermined subspace.

6. The data processing apparatus according to claim 1,
also comprising:
a modulation unit configured to perform calculation of a target amplitude based on the current state data,
and wherein
the error calculation unit calculates, taking advantage of the target amplitude, error values which is related to amplitude homogeneity of the current state data.

7. The data processing apparatus according to claim 6,
wherein the state data processing unit also performs projection of the state data onto a predetermined subspace defined by the target amplitude.

8. The data processing apparatus according to claim 1,
also comprising:
a modulation unit configured to perform calculation of a gain value based on the current state data,
and wherein,
the state data processing unit is also configured to update an archetype monostable/bistable potential with the gain value calculated based on the current state data.

9. The data processing apparatus according to claim 1,
also comprising:
a modulation unit configured to dynamically determine a change rate of the error values,
and wherein the error calculation unit performs the time evolutional process on the error values to update the current error values based on the change rate of the error values, the error values, the state data, and the cost function.

10. The data processing apparatus according to claim 8,
wherein the gain value also depends on constant values that are calculated using the parameters of the cost function prior to the start of the time evolutional process.

11. The data processing apparatus according to claim 1,
wherein the state data processing unit performs the time evolutional process on the state data to update the current state data based on the cost function by using an Ising model quantum computation device, the Ising model quantum computation device comprising:
a parametric oscillator that parametrically oscillates a plurality of pseudo spin pulses, the plurality of pseudo spin pulses being in correspondence with a plurality of Ising model spins in a pseudo manner and having mutually an identical oscillation frequency;
a ring resonator in which the plurality of pseudo spin pulses circularly propagate;
a tentative spin measuring unit that tentatively measures phases and amplitudes of the plurality of pseudo spin pulses every time the plurality of pseudo spin pulses circularly propagate in the ring resonator to tentatively measure pseudo spins of the plurality of pseudo spin pulses;
a FPGA device configured as calculate, according to the output of the cost evaluation unit and the error values, the data which is to be synthesized to the measured pseudo spin pulses to obtain the time evolution of the state data, and output the result of the time evolution of the state data.

12. The data processing apparatus according to claim 1,
wherein the state data processing unit performs the time evolutional process on the state data and updates data based on the cost function by using a GPU or an FPGA or an analog electronic computing device configured to perform calculations of the state data, and the error values.

13. A data processing method using a data processing apparatus having a state data processing unit, a cost evaluation unit, and an error calculation unit to solve a given problem comprising steps of:
configuring the state data processing unit to iterate update of state data by a predetermined time evolutional process;
configuring the cost evaluation unit to evaluate a cost function for current state data; and
configuring the error calculation unit to calculate error values relating to amplitude homogeneity of the current state data;
wherein the state data is a set of variables, and the state data processing unit is configured to perform the time evolutional process on the state data to update the current state data based on the cost function and the error values which are relating to amplitude homogeneity of the current state data calculated by the error calculation unit.

14. A data processing method according to the claim 13,
said data processing apparatus also comprising a modulation unit, and the method further comprising steps of:
configuring the modulation unit to update error variables relating to amplitude homogeneity and constraints, to calculate a coupling term between the constraints and the current state data, and to calculate gain and saturation,
configuring the state data processing unit to calculate an injection term, to update the state data, and to apply projection to the state data onto a valid subspace during configuring the state data processing unit to iterate update of state data by a predetermined time evolutional process,
and configuring the error calculation unit to calculate error values relating to amplitude homogeneity of the current state data, and relating to constraints,
wherein the iteration continues until a predetermined condition is satisfied.
